(19) United States
(12) Patent Application Publication
(10) Pub. No.: US 2024/0105002 A1
(43) Pub. Date: Mar. 28, 2024

(54) GAMING MACHINE AND METHOD WITH AN ENHANCED WAGERING MODE

(71) Applicant: SG Gaming, Inc., Las Vegas, NV (US)

(72) Inventors: Jeffry NAUMAN, Yorkville, IL (US); Brett GRIMES, Chicago, IL (US); Sarah LEGGETT, Chicago, IL (US); Matthew ZWOLINSKI, Oak Lawn, IL (US)

(21) Appl. No.: 17/950,231

(22) Filed: Sep. 22, 2022

(51) Int. Cl. G07F 17/32

(52) U.S. Cl. CPC G07F 17/3244; G07F 17/3209; G07F 17/3213; G07F 17/3269

(57) ABSTRACT

Disclosed are gaming methods and a system that utilize a presentation assembly configured to present a series of spins of a plurality of reels arranged in an array. Prizes for winning spin outcomes are awarded according to a first pay table. Upon a triggering event, a timed enhanced wagering period is initiated. The size of the array may also be modified in response to the triggering event. Symbols on the plurality of reels may also be modified. A second pay table is substituted for the first pay table and a second set of larger wager options are made available. During the enhanced wagering period, prizes are awarded according to the second pay table. At the conclusion of the enhanced wagering period, the initial set of reels and the first pay table are restored, and the second set of wager options is removed.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2022, SG Gaming, Inc.

### FIELD OF THE INVENTION

The present invention relates to a technological improvement to gaming systems, gaming machines, and methods thereon and, more particularly, to new and improved wagering in connection with a game feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return, To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

Disclosed are gaming methods and a system that utilize a presentation assembly configured to present a series of spins of a plurality of reels arranged in an array. Prizes for winning spin outcomes are awarded according to a first pay table. Upon a triggering event, a timed enhanced wagering period is initiated. The size of the array may also be modified in response to the triggering event. Symbols on the plurality of reels may also be modified. A second pay table is substituted for the first pay table and a second set of larger wager options are made available. During the enhanced wagering period, prizes are awarded according to the second pay table. At the conclusion of the enhanced wagering period, the initial set of reels and the first pay table are restored, and the second set of wager options is removed. Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is a flowchart for a data processing method that corresponds to instructions executed by a controller, according to an embodiment of the present invention.

FIG. 4 illustrates an example of a game presentation in accordance with one or more embodiments.

FIGS. 5A and 5B illustrate an example of a bet panel in accordance with one or more embodiments.

FIGS. 6-7 illustrate examples of expanded array game presentations in accordance with one or more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

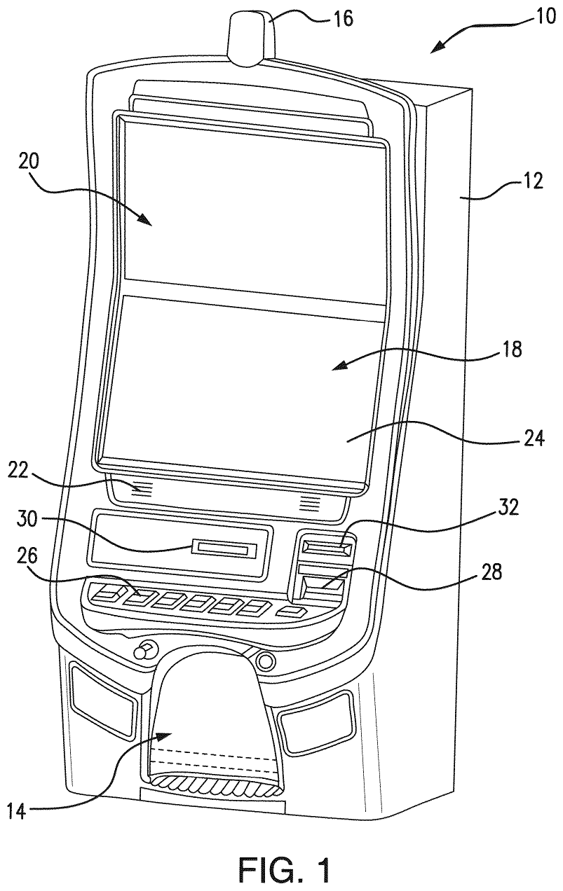

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

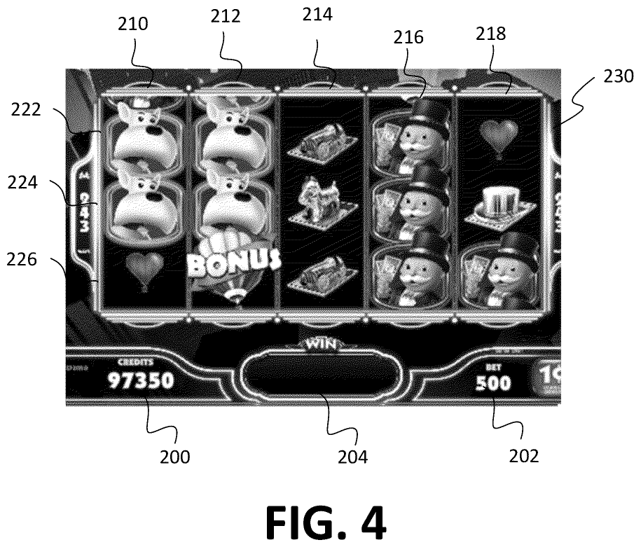

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

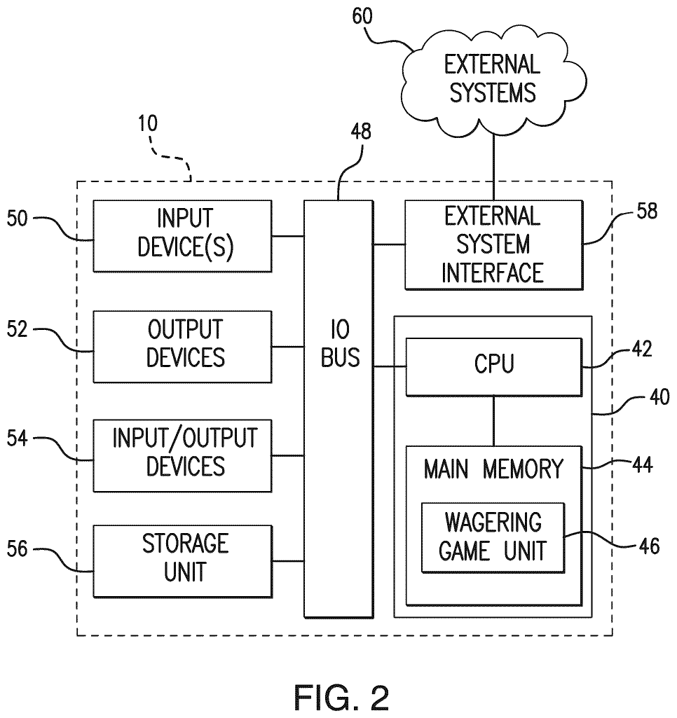

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44, The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

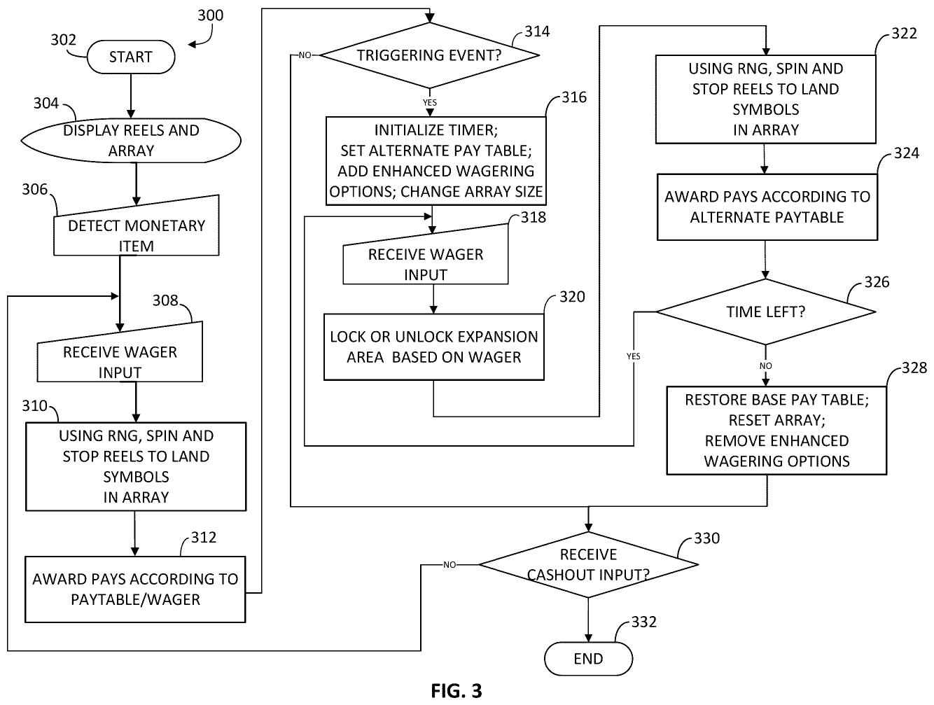

Referring now to FIG. 3, there is shown a flowchart representing one data processing method 300 corresponding to at least some instructions stored and executed by the game-logic circuitry 40 in FIG. 2 to perform operations according to an embodiment of the present invention. The data processing method 300 is described below in connection with an exemplary representation of a set of game presentations in FIGS. 4-7.

The data processing method commences at step 302. At step 304, the game-logic circuitry controls one or more presentation devices (e.g., mechanical-reel display device, video display device, or a combination thereof) that presents a plurality of symbol-bearing reels and an array of symbol positions. Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. The number of symbol positions in different rows and/or different columns may vary from each other. The reels may be associated with the respective columns of the array such that the reels spin vertically, and each reel populates a respective column. In another embodiment, the reels may be associated with the respective rows of the array such that the reels spin horizontally, and each reel populates a respective row. In yet another embodiment, the reels may be associated with respective individual symbol positions of the array such that each reel populates only its respective symbol position.

In the example shown in FIG. 4, the presentation device presents a three-by-five array 230 comprising three rows 222, 224, 226 and five columns 210, 212, 214, 216, and 218. Each column is associated with a respective reel such that the reel populates the three symbol positions in the associated column. The reels bear a plurality of symbols. In one embodiment, the plurality of symbols includes standard symbols shown in FIG. 4. Each reel may contain one or more stacks (i.e., clumps) of symbols that appear adjacent to each other along the reel. A stack of symbols may consist of two, three, four, or more like adjacent symbols. For example, a clump of two bonus symbols is illustrated in the top two rows 222, 224 of the first and second columns 214,216 and all three rows 224, 226,228 of the fourth column 218 of FIG. 4. Further, adjacent reels may contain one or more “mega” bonus symbols 206 that move as one block as the reels spin. For example, a “mega” value bearing symbol may comprise a two-row high square spanning the second and third columns 212, 214.

Returning to FIG. 3, at step 306, the game-logic circuitry detects, via a value input device, a physical item associated with a monetary value that establishes a credit balance. As shown in FIG. 4, the credit balance may be shown on a credit meter 200 of the gaming machine.

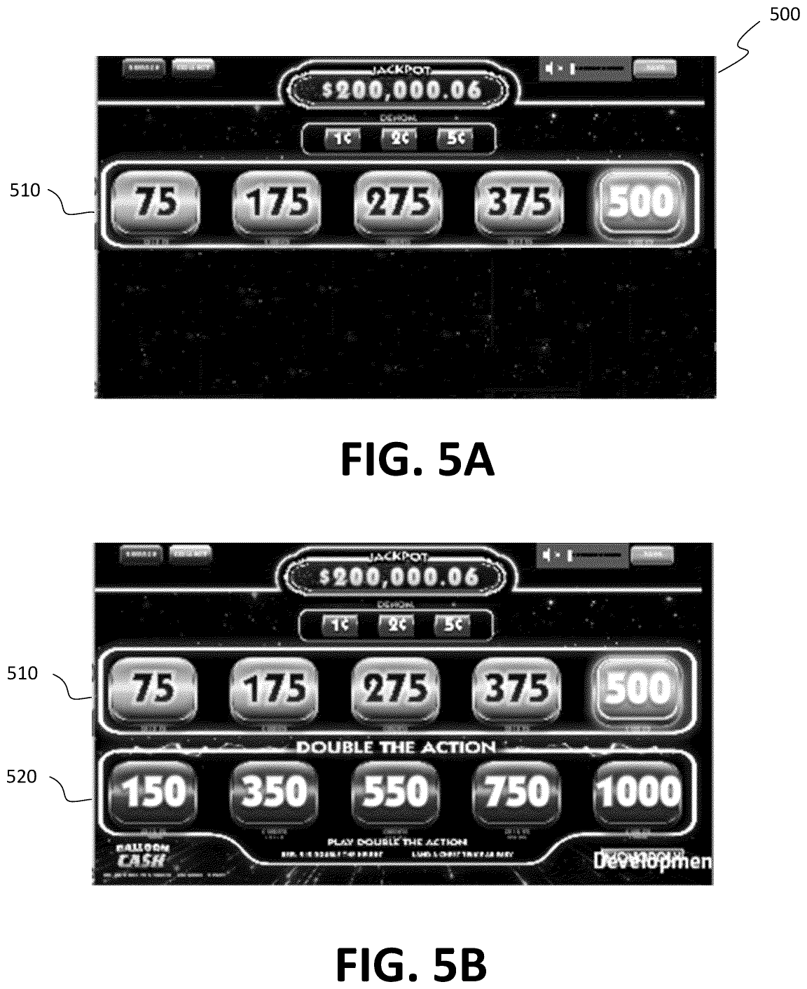

At step 308, the game-logic circuitry initiates a wagering game cycle in response to an input indicative of a wager covered by the credit balance. To initiate a spin of the reels, the player may press a wager key selected from a first set of base game wagers 510 displayed on a bet panel 500 (FIG. 5A). As shown in FIG. 4, the selected wager may be shown on a bet meter 202.

At step 310, using an RNG, the game-logic circuitry spins and stops the reels to randomly land symbols from the reels in the array, which may be in visual association with one or more pay lines or other pay arrangements. The reel spin may be animated on a video display by depicting symbol-bearing strips moving vertically across the display and synchronously updating the symbols visible on each strip as the strip moves across the display.

The method 300 illustrated describes a base game and an enhanced wagering period triggered during play of the base game. In one or more alternate embodiments, the concepts of offering enhanced wagers combined with an alternate pay table and an enhanced array during a timed enhanced wagering period may apply to a base game, a bonus game, or both. The enhanced wagering period continues until an enhanced wagering period timer expires, and the method either concludes or returns to the base game depending on whether the player cashes out at step 330 or places another base game wager at step 308.

At step 312, the game logic circuitry awards pays for winning combinations of symbols in accordance with a base game pay table. To animate a pay, the display may apply a border, pattern, color change, background change, watermark, or other distinguishing characteristic to the winning payline and/or winning symbols that contributed to the pay. The base game pay table may, for example, include “ways pays”, “line pays,” “scatter pays” or combinations thereof. In the embodiments described here, winning combinations are evaluated as “ways pays”, in which like symbols in winning combinations appear on adjacent reels without the requirement to be on a specified pay line or directly adjacent to one another. (This is in contrast to pay line combinations, in which like symbols must align along one or more pay lines running from left to right across the reels.) In the example shown in FIG. 4, the three by five array 230 has 243 (3⁵) ways to win. In a 243 ways slot machine, any combination of three or more matching symbols can be a win, provided they appear anywhere on adjacent reels, starting from the first reel and going left to right. Only one instance of a symbol on a reel is included in a winning combination. Thus, the best combination is a five of a kind.

In alternate embodiments, as alluded to above, line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. In the example shown in FIG. 4, standard pays may be limited to line pays along three horizontal paylines starting from the leftmost reel: a first payline spanning the middle row 224 of the array 230, a second payline spanning the top row 222 of the array 230, and a third payline spanning the bottom row 226 of the array 230.

Regardless of the type of pays in the base game pay table, any awarded pays are added to the win meter 204 at step 312 and the game logic circuitry proceeds to step 314.

At step 314, the game-logic circuitry determines whether an enhanced wagering period triggering event has occurred. The game-logic circuitry may employ various means to determine a triggering event for the bonus. For example, without limitation, the triggering event may be based on a random determination using the RNG, when a “catalyst” symbol appears on a certain reel, when one or more predefined scattered symbols appear, after a certain number of base game non-bonus spins have occurred, etc. In some embodiments, a randomly occurring triggering event may be a “must hit by” event in which the probability of the triggering event occurring increases until there is virtually no chance that the triggering event will not be randomly selected by the game-logic circuitry. In a preferred embodiment, multiple gaming machines 10 may be linked such that the triggering event initiates an enhanced wagering period on each of the gaming machines 10 in a “community event.” If no triggering event has occurred, the game-logic circuitry immediately proceeds from step 314 to step 330 to determine whether the player wishes to play another base game cycle, as described above.

If, however, a triggering event has occurred at step 314, the game-logic circuitry transitions into an enhanced wagering period at step 316. The base game mode offers five wagers of 75 cents, 175 cents, 275 cents, 375 cents and 500 cents, corresponding to pay table multipliers of 1×, 2×, 3×, 4× and 5× (FIG. 5A; 510). During the mode of the enhanced wagering period, an additional row (FIG. 5B; 520) of wager options is offered to the player. Each of these wagers is twice as high (150 cents, 350 cents, 550 cents, 750 cents and 1000 cents) as the base game wager above it, but still provides the same IX-5X pay table multiplier as its counterpart in the base game wager row 510. In this example, the wagers increase non-linearly in size from left to right, but may, in some embodiments, progress linearly.

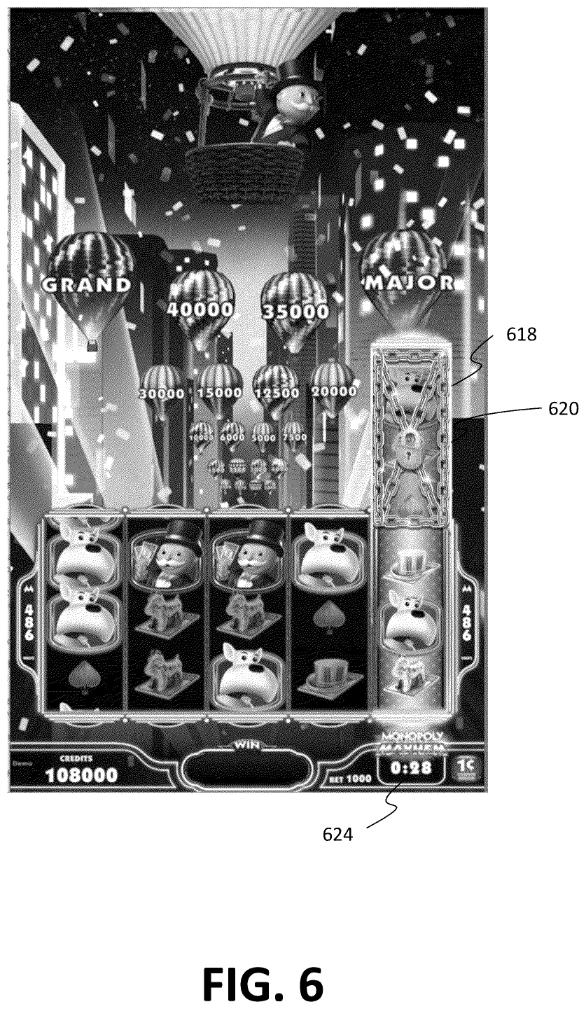

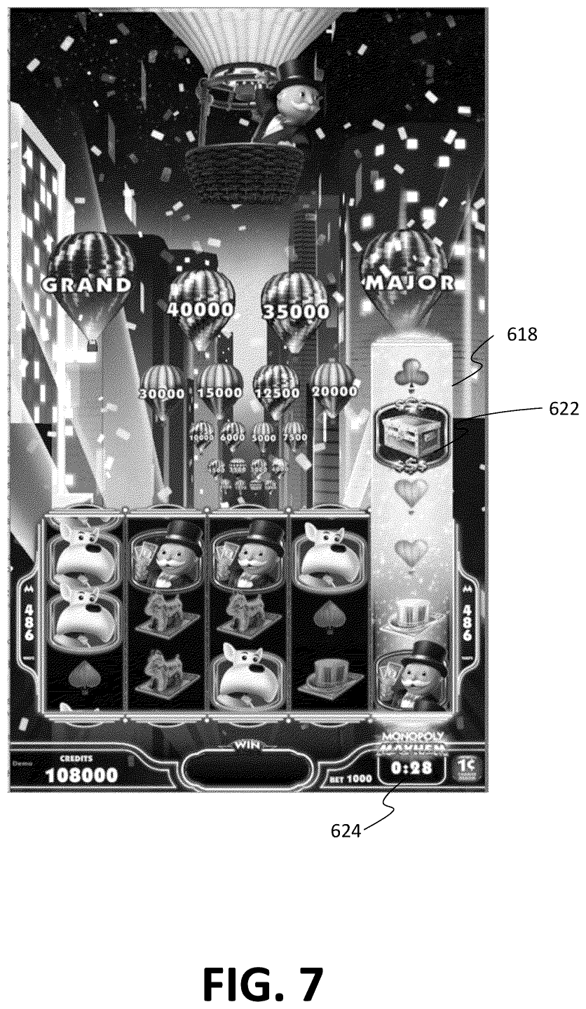

Initialization of the enhanced wagering period at step 316 also includes substitution of an enhanced wagering period pay table for the base game pay table, potential modification of the symbols on the reels and modification of the size of the array by alteration of the height of the visible portion of one or more reels. As illustrated in FIGS. 6-7, the array thus may be modified in size, for example, by adding one or more rows to at least one of the columns of the array. In the example of FIG. 6, the fifth column 618 has been expanded by adding three rows to the top of the fifth column 618, exposing three additional rows at the top of the fifth reel. In the example of FIG. 6, this expansion area 620 is shown as locked, as indicated by chains over the three additional rows of the fifth reel 618. If the player unlocks this area during the enhanced wagering period by placing one of the wagers in the additional row of wager options 520 (see step 318, below), the expansion area is unlocked, as illustrated in FIG. 7, and the number of ways to win increases from 243 to 486 (3×3×3×3×6).

It should be noted that the enhanced wagering period typically does not offer a substantially higher expected value (EV) over the base game configuration, nor does the selection of a wager from the additional row of wager options 520 during the enhanced wagering period offer a substantially higher EV over the selection of a wager from the first set of wager options 510. As an example, the base game may provide an EV of 87.5 percent, while, during the enhanced wagering period, the selection of a wager from the first set of wager options 510 may offer an EV of 87.5 percent and the selection of a wager from the additional row of wager options 520 may offer an EV of 87.9 percent.

To substantially maintain the base game EV during the enhanced wagering period, the enhanced wagering period pay table may be a modified version of the base game pay table. For example, certain pays may be reduced to zero on the pay table during the enhanced wagering period, reducing the number of pay table wins. Most of the EV from these removed wins is instead concentrated in a bonus game offered during the enhanced wagering period. Such a bonus game leads to increased volatility and excitement during the enhanced wagering period. Though any bonus game presentation may be used, in one example, the presentation assembly presents the bonus game as a display filled with balloons, each bearing a prize value. As the bonus game progresses, some of the balloons begin to float away, carrying their prizes with them. At the conclusion of the bonus game presentation, the prizes borne by any balloons still remaining on the display are awarded to the player.

A trigger symbol 622 for initiating the bonus game may be placed, for example, on the fifth reel 618 (FIG. 7). Placement of the trigger symbol on the fifth reel 618 encourages the player to choose a wager from the additional row of wager options 520 because such a wager will unlock the expansion area and provide more spaces in the array in which the trigger symbol may land. While selecting a wager from the additional row of wager options 520 unlocks the expansion area of the array and makes it more likely that the player will trigger the bonus game during the enhanced wagering period, the player typically does not receive substantially higher EV for placing such a wager. The player is simply encouraged to select from the increased wager amounts in order to receive the most excitement and best entertainment value from the enhanced wagering period.

During the enhanced wagering period, to maintain a substantially same EV for a wager selected from the first set of wager amounts 510 as for a wager selected from the additional row of wager options 520, adjustments may be made to the weights of certain reel symbols and to the probability of receiving certain awards in the bonus game. For example, the weight of the triggering symbol on the fifth reel may be adjusted based on the row from which the wager was selected. These examples are non-limiting. Any method or methods of maintaining a substantially same EV for the base game and for the various wagers of the enhanced wagering period fall within the spirit and scope of the inventions.

In the preferred embodiment, initiation of the enhanced wagering period at step 316 also includes initialization of a timer (FIGS. 6-7; 224) the expiration of which will conclude the enhanced wagering period at step 326. For example, the timer may be initialized at three minutes and count down. In alternate embodiments, the timer may be initialized at zero and count up to a predetermined value.

At step 318, the game-logic circuitry initiates an enhanced wagering period game cycle in response to an input indicative of a wager covered by the credit balance. As at step 308, to initiate a spin of the reels, the player may press a wager key selected from the first set of base game wagers 510 displayed on the bet panel 500 or a wager key selected from the second set of enhanced wagering period wagers 520 (FIG. 5B). As shown in FIG. 4, the wager may be shown on the bet meter 202.

At step 320, if the player selected one of the enhanced wagers offered in the enhanced wagering row 520, the locked expansion area of the array may be unlocked with the benefits to the player described above with respect to step 316. If the player does not choose one of the enhanced wagers, the expansion area remains locked or, if an immediately preceding enhanced wagering period wager had unlocked the expansion area, the expansion area is relocked.

At step 322, using the RNG, the game-logic circuitry spins and stops the reels to randomly land symbols from the reels in the array as described above with respect to step 310.

At step 324, the game logic circuitry awards pay amounts for the winning combination of symbols in accordance with the enhanced wagering period pay table.

At step 326, the game-logic circuitry determines whether the enhanced wagering period is over, for example, if the timer initialized at step 316 has expired. If the enhanced wagering period has not ended, the player is offered another enhanced wagering period wager opportunity at step 318. If, however, the enhanced wagering period has ended, the pay table reverts to the base game pay table, the reels return to their base game configuration and any enhancements to the size of the array are removed, as is the enhanced wagering row 520. The player may then enter a cash out input at step 330, which terminates the method at step 332, or may return to regular base game play with another base game wager at step 308.

In this description, numerous specific details are set forth. However, it is understood that embodiments of the invention may be practiced without these specific details or with additional details or in various combinations. While the corresponding positions of the wagers shown in the base game wager row 510 and the enhanced wager row 520 of FIG. 5B are tied to the same 1×, 2×, 3×, 4× and 5× pay table multipliers, in alternate embodiments, the wagers on the enhanced row 520 might be tied to different multipliers, for example, IX, 2×, 4×, 6×, 8×. In some alternate embodiments, the enhanced wagering period pay table, rather than being substantially equal to the base game pay table, may offer a different EV; for example, an improved EV for wagers selected from the enhanced wagering row 520.

In other examples, as alluded to above, the enhanced wagering period may not be timed and instead may be based on a spin counter and a predetermined number of spins, by a random “mystery” event, by an event on another of a linked community of gaming machines, etc.

In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine, the method comprising the operations of:
presenting, by a presentation assembly, a plurality of symbol-bearing reels and an array comprising a plurality of rows and a plurality of columns; and
accepting, via a value input device, a physical item associated with a monetary value to establish a credit balance;
in response to acceptance, via one or more electronic input devices, of a first wager selected from a first set of wagering options, conducting, by game-logic circuitry, an initial series of spins of the plurality of reels, each spin including spinning and stopping the plurality of reels to land symbols from the plurality of symbols in the array, the landed symbols indicating a base game winning spin when the landed symbols define at least one winning outcome according to a first pay table;
paying, by the game-logic circuitry, the base game winning spin according to the first pay table;
upon a triggering event, initializing, by the game-logic circuitry, an enhanced wagering period by replacing the first pay table with a second pay table different from the first pay table and offering a second set of wagering options comprising wagers higher than the wagers in the first set of wagering options;
in response to acceptance, via at least one of the one or more electronic input devices, of a second wager placed during the enhanced wagering period, conducting, by the game-logic circuitry, a subsequent series of spins of the plurality of reels, each of the subsequent spins including spinning and stopping the plurality of reels to land symbols from the plurality of symbols in the array, the landed symbols indicating an enhanced wagering period winning spin when the landed symbols define at least one winning outcome according to the second pay table;
paying, by the game-logic circuitry, the enhanced wagering period winning spin according to the second pay table;
at a conclusion of the enhanced wagering period, replacing the second pay table with the first pay table and removing the second set of wagering options; and
receiving, via at least one of the one or more electronic input devices, a cash out input that initiates a payout from the credit balance via a value output device.

2. The method of claim 1, wherein initializing an enhanced wagering period further comprises expanding the size of the array to create a locked expansion area, wherein the locked expansion area is removed from the array at the conclusion of the enhanced wagering period.

3. The method of claim 2, further comprising, in response to the second wager being selected from the second set of wagering options, unlocking the expansion area.

4. The method of claim 2, further comprising, in response to the second wager being selected from the first set of wagering options, leaving the expansion area locked.

5. The method of claim 1, wherein initializing the enhanced wagering period further comprises initializing an enhanced wagering period timer.

6. The method of claim 5, wherein the conclusion of the enhanced wagering period comprises expiration of the enhanced wagering period timer.

7. The method of claim 1, wherein expanding the size of the array comprises increasing the height of at least one column of the array.

8. The method of claim 1, wherein initializing the enhanced wagering period further comprises modifying the symbols on at least one of the plurality of reels.

9. The method of claim 8, wherein modifying the symbols on at least one of the plurality of reels comprises adding a trigger symbol for a bonus game not included in the first pay table.

10. The method of claim 1, wherein an expected value of a wager selected from the first set of wagering options and an expected value of a wager selected from the second set of wagering options are substantially equal.

11. A gaming system comprising:
a gaming machine including a presentation assembly configured to present a plurality of symbol-bearing reels and an array comprising a plurality of rows and a plurality of columns; and
game-logic circuitry configured to perform the operations of:
accepting, via a value input device, a physical item associated with a monetary value to establish a credit balance;
in response to acceptance, via one or more electronic input devices, of a first wager selected from a first set of wagering options, conducting, by game-logic circuitry, an initial series of spins of the plurality of reels, each spin including spinning and stopping the plurality of reels to land symbols from the plurality of symbols in the array, the landed symbols indicating a base game winning spin when the landed symbols define at least one winning outcome according to a first pay table;
paying, by the game-logic circuitry, the base game winning spin according to the first pay table;
upon a triggering event, initializing, by the game-logic circuitry, an enhanced wagering period by replacing the first pay table with a second pay table different from the first pay table and offering a second set of wagering options comprising wagers higher than the wagers in the first set of wagering options;
in response to acceptance, via at least one of the one or more electronic input devices, of a second wager placed during the enhanced wagering period, conducting, by the game-logic circuitry, a subsequent series of spins of the plurality of reels, each of the subsequent spins including spinning and stopping the plurality of reels to land symbols from the plurality of symbols in the array, the landed symbols indicating an enhanced wagering period winning spin when the landed symbols define at least one winning outcome according to the second pay table;
paying, by the game-logic circuitry, the enhanced wagering period winning spin according to the second pay table;
at a conclusion of the enhanced wagering period, replacing the second pay table with the first pay table and removing the second set of wagering options; and
receiving, via at least one of the one or more electronic input devices, a cash out input that initiates a payout from the credit balance via a value output device.

12. The gaming system of claim 11, wherein initializing an enhanced wagering period comprises expanding the size of the array to create a locked expansion area, wherein the locked expansion area is removed from the array at the conclusion of the enhanced wagering period.

13. The gaming system of claim 12, further comprising, in response to the second wager being selected from the second set of wagering options, unlocking the expansion area.

14. The gaming system of claim 12, further comprising, in response to the second wager being selected from the first set of wagering options, leaving the expansion area locked.

15. The gaming system of claim 11, wherein initializing the enhanced wagering period further comprises initializing, by the game-logic circuitry, an enhanced wagering period timer.

16. The gaming system of claim 15, wherein the conclusion of the enhanced wagering period comprises expiration of the enhanced wagering period timer.

17. The gaming system of claim 11, wherein expanding the size of the array comprises increasing, by the game-logic circuitry, the height of at least one column of the array.

18. The gaming system of claim 11, wherein initializing the enhanced wagering period further comprises modifying, by the game logic circuitry, the symbols on at least one of the plurality of reels.

19. The gaming system of claim 18, wherein modifying the symbols on at least one of the plurality of reels comprises adding a trigger symbol for a bonus game not included in the first pay table.

20. The gaming system of claim 11, wherein an expected value of a wager selected from the first set of wagering options and an expected value of a wager selected from the second set of wagering options are substantially equal.
